(19) United States
(12) Patent Application Publication
(10) Pub. No.: US 2026/0354355 A1
(43) Pub. Date: Nov. 12, 2026

(54) CHOREOGRAPHED ACTIVATION OF COMPRESSED AIR NOZZLES FOR AN AQUARIUM

(71) Applicant: Georgia Aquarium Inc., Atlanta, GA (US)

(72) Inventors: Gregory Philip Hemric, Powder Springs, GA (US); Russell S. Sorrow, Fayetteville, GA (US); Elizabeth Hart Gates, Decatur, GA (US); Stephen Hartter, Marietta, GA (US); Kathryn Mendryk, Decatur, GA (US); Kimberly Stone, Tyrone, GA (US)

(21) Appl. No.: 19/201,514

(22) Filed: May 7, 2025

(51) Int. Cl. A01K 63/00; A01G 33/00; A63J 17/00

(52) U.S. Cl. CPC A01K 63/006; A01G 33/00; A63J 17/00

(57) ABSTRACT

Systems and methods for choreographic activation of compressed air nozzles of an array of compressed air nozzles. The system comprises one or more compressed air sources, a plurality of spatially distributed air nozzles connected with the one or more compressed air sources by one or more air conduits, and an valve controller configured to activate each of the plurality of spatially distributed air nozzles in accordance with a temporal sequence defining a plurality of activation times for activating one or more air nozzles of the plurality of spatially distributed air nozzles. The spatially distributed air nozzles are located above a water surface of an aquarium tank and are oriented to blow air onto the water surface. The aquarium tank contains bioluminescent algae which emit bioluminescence in response to air blown onto the surface of the water. This results in a visually synchronized, choreographed bioluminescent display.

### FIELD OF THE INVENTION

The present disclosure relates generally to systems and method for choregraphing activation of compressed air nozzles of an array of compressed air nozzles. Specifically, various embodiments relate to choreographing activation of compressed air nozzles blowing air onto a microorganism culture to excite microorganisms to luminesce.

### BACKGROUND

In educational environments (e.g., aquariums) focused on the natural world, there is a need to demonstrate natural phenomena to visitors and students. To help students learn, it is important to provide demonstrations in novel and memorable ways. When working with living organisms, it is also important to consider the safety of those organisms as well. Therefore, the concepts discussed herein provide unique ways to safely demonstrate natural phenomena in a controlled environment.

### BRIEF SUMMARY

Described herein are systems and methods for a choreographed activation of compressed air nozzles for an aquarium. The system comprises a plurality of features that provide a visually synchronized, choreographed bioluminescent display, wherein a dinoflagellates' natural luminescence emission is activated in time with an accompanying musical arrangement.

In various embodiments a system is provided for choreographing activation of compressed air nozzles for an aquarium. The system comprises one or more compressed air sources, a plurality of spatially distributed air nozzles connect with the one or more compressed air sources by one or more air conduits, and an electronic controller configured to activate each of the plurality of spatially distributed air nozzles in accordance with a temporal sequence defining a plurality of activation times for activating one or more air nozzles of the plurality of spatially distributed air nozzles.

In certain embodiments the system further comprises an aquarium tank. In certain embodiments, the plurality of spatially distributed air nozzles are located above a water surface of the aquarium tank and each of the plurality of spatially distributed air nozzles is oriented to blow air on the water surface. In certain embodiments, the aquarium tank includes bioluminescent algae floating on the water surface and blowing air causes the bioluminescent algae to luminesce. In certain embodiments, the plurality of spatially distributed air nozzles are defined within a single plane. In certain embodiments, the temporal sequence is stored in memory, and wherein the temporal sequence identifies a set of one or more of the plurality of spatially distributed air nozzles for activation at each of the plurality of activation times. In certain embodiments, a different set of the plurality spatially distributed air nozzles are activated during subsequent activation times of the plurality of activation times. In certain embodiments, the electronic controller synchronizes the temporal sequence with music by initiating the temporal sequence simultaneously with initiation of a song. In certain embodiments, the electronic controller receives input indicating initiation of a song and initiates the temporal sequence. In certain embodiments, the nozzles are controlled using solenoid valves. In certain embodiments, the one or more air conduits are part of an air distribution manifold, and wherein the air distribution manifold maintains at least substantially consistent air pressure at each nozzle. In certain embodiments, at least one nozzle is moveable.

In various embodiments, a method is provided that includes initiating a music sequence. The method additionally comprises synchronously activating each of a plurality of spatially distributed air nozzles in accordance with a temporal sequence defining a plurality of activation times for activating one or more air nozzles of the plurality of spatially distributed air nozzles. In certain embodiments, activating an air nozzle of the plurality of spatially distributed air nozzles comprises releasing compressed air from the air nozzle.

### BRIEF DESCRIPTION OF THE SEVERAL VIEWS OF THE DRAWINGS

Reference will now be made to the accompanying drawings, which are not necessarily drawn to scale, and wherein:

FIG. 1A is a schematic diagram of a bioluminescent microorganism exhibit according to embodiments;

FIG. 1B is a perspective view of the support structure and the spatially distributed air nozzles above an aquarium tank according to embodiments;

FIG. 1C is another perspective view of the support structure and the spatially distributed air nozzles positioned above the aquarium tank according to embodiments;

FIG. 1D is another perspective view of the support structure and the spatially distributed air nozzles positioned above the aquarium tank according to embodiments;

FIG. 2 is a schematic of the top view of the aquarium exhibit according to embodiments;

FIG. 3A is a schematic of a hardware system according to embodiments;

FIG. 3B is an image of the control hardware according to embodiments;

FIG. 4A is a timeline of the activation and deactivation of nozzles according to embodiments;

FIG. 4B depicts a schematic of a bioluminescent microorganism exhibit with active nozzles at a first time according to embodiments;

FIG. 4C depicts a schematic of an aquarium exhibit with active nozzles at a second time according to embodiments;

FIG. 5 depicts a schematic of an aquarium exhibit with multiple nozzles controlled by a single valve according to embodiments;

FIG. 6A provides a timeline of the activation and deactivation of nozzles according to embodiments;

FIG. 6B depicts a schematic of an aquarium exhibit with single nozzles controlled by single valve and multiple nozzles controlled by a single valve at a first time according to embodiments;

FIG. 6C depicts a schematic of an aquarium exhibit with single nozzles controlled by single nozzles and multiple nozzles controlled by a single valve at a second time according to embodiments; and

FIG. 7 is a block diagram depicting a method of programming a new temporal sequence according to embodiments; and

FIG. 8 is a block diagram depicting a method of exciting microorganisms to luminesce, according to embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Various embodiments of the present disclosure will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

As used herein, the term “substantially” generally means the majority of the time. Any provided value, whether or not it is modified by term such as “substantially” all refer to and hereby disclose associated values or ranges of values thereabout, as described above.

### Overview

Bioluminescent dinoflagellates are single-celled marine organisms that emit a natural glow when disturbed. These organisms live in saltwater environments (e.g., the ocean), and can be cultured in saltwater aquariums for viewing by visitors and students.

A bioluminescent dinoflagellates microorganism exhibit uses compressed air applied to a microorganism culture through a manifold distribution system to disturb/excite the microorganism to luminesce. As discussed herein, the compressed air application is synchronized with music, such as a pre-programmed sequence of music. The manifold distribution system is used to deliver compressed air from a compressed air source (e.g., an air compressor) to the aquarium tank. The manifold distribution system or at least a portion of the manifold distribution system is located above the surface of the water and is configured to blow air on the water to excite the microorganisms to luminesce. The manifold distribution system comprises valves (e.g., solenoid valves) to release controlled bursts of air onto a small area on the surface of the water in the aquarium, and consequently onto the microorganism culture in that small area from above, stimulating bioluminescent dinoflagellates to emit bioluminescence in response. The manifold distribution system is pre-programmed to release controlled bursts of air in time with music to excite the microorganisms to luminesce in time with the music. The result is a visually synchronized, choreographed bioluminescent display, wherein the dinoflagellates' natural luminescence emission is activated in time with an accompanying musical arrangement.

In just one example, operation of the valves is controlled by a valve controller. The controller may store one or more predefined sequences of valve operations-each valve operations releasing a burst of air through a corresponding nozzle onto the surface of the water in the aquarium, and consequently onto the bioluminescent dinoflagellates. Each of the predefined sequences of valve operation are choreographed to a corresponding audio track (e.g., a song). Upon initiating the audio track (e.g., via a speaker system or other audio output device), the controller may initialize the corresponding predefined sequence of valve operations such that the system causes the bioluminescent dinoflagellates to luminesce in a manner that appears choreographed with the audio track.

### System

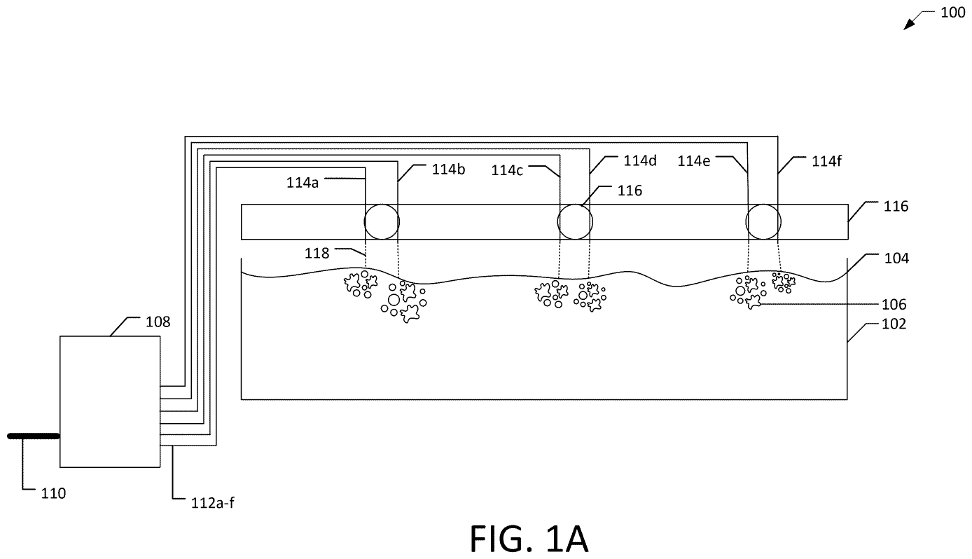

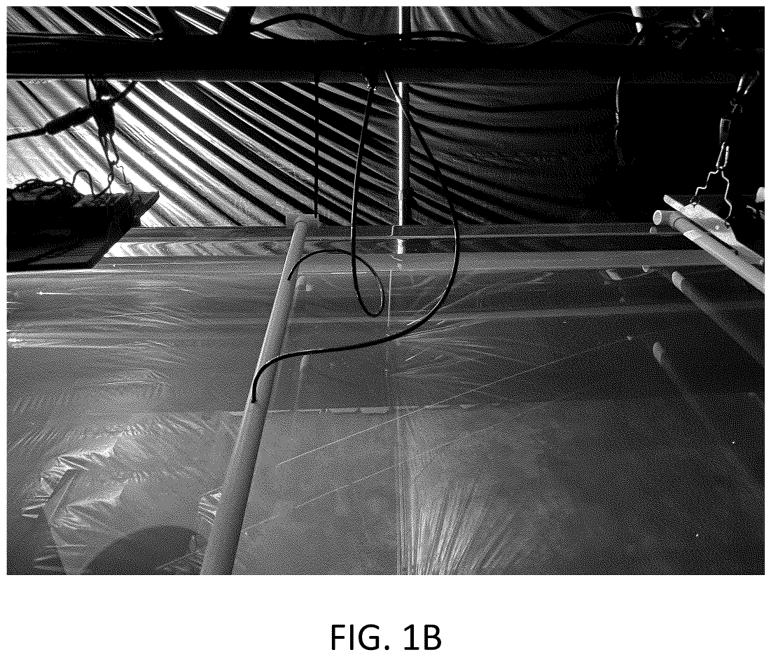

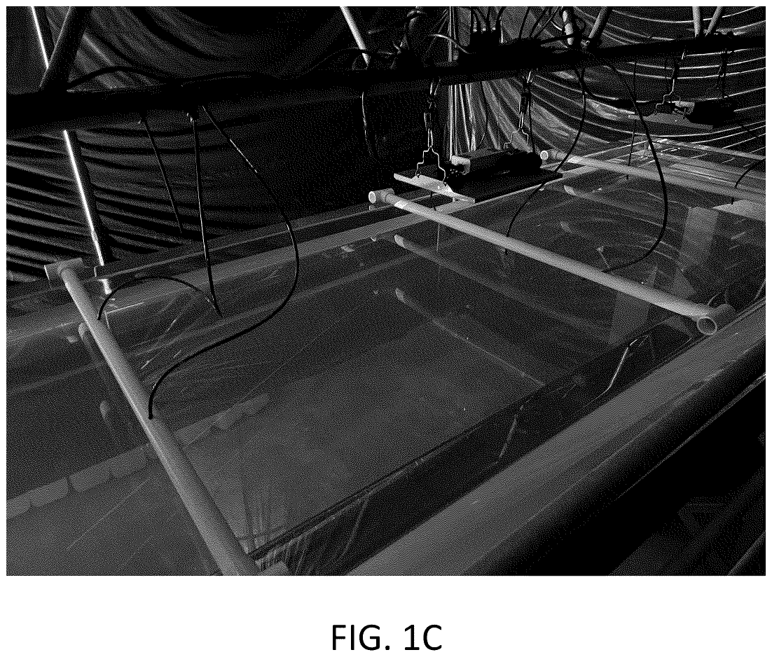

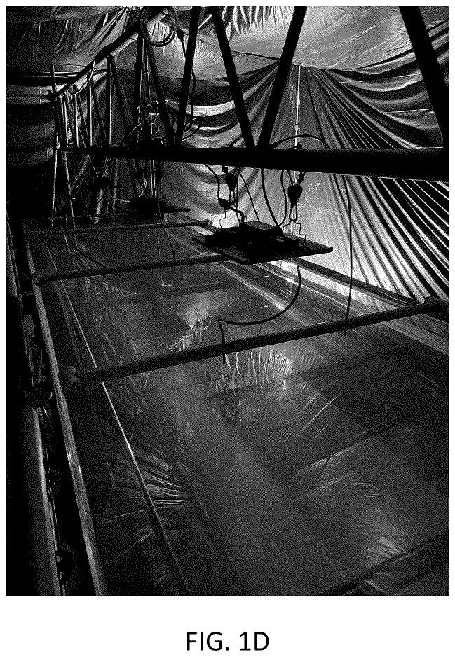

FIG. 1A provides a schematic of a bioluminescent microorganism exhibit 100, according to embodiments of the present disclosure. The bioluminescent microorganism exhibit 100 comprises an aquarium tank 102 filled with water (e.g., saltwater having characteristics similar to those of the ocean). The aquarium tank 102 contains microorganisms 106 that are dispersed on the surface of the water 104. Specifically, the microorganisms 106 are bioluminescent dinoflagellates which float on/near the surface of the water. The cultivation and sustained viability of the dinoflagellate culture within the bioluminescent microorganisms exhibit 100 environment are supported by maintaining specific and controlled water parameters. Optimal conditions for promoting dinoflagellate health and bioluminescent activity include a salinity range of approximately 32-34 parts per thousand (ppt), a pH range between 8.00 and 8.20, alkalinity levels maintained between 150-180 ppm (as CaCO₃), and a stable temperature range of 68 °F to 74 °F. Ambient temperature control may be employed exclusively; without in-system thermal regulation elements—such as heaters or heat exchangers.

Filtration and circulation systems may be omitted to prevent mechanical disturbance of the culture. Instead, water exchanges are performed using a blend of reverse osmosis (RO) saltwater and Guillard's F/2 algal culture medium concentrate to replenish essential nutrients and maintain water quality.

To preserve optical clarity for exhibit viewing and minimize algal biofouling on transparent surfaces, the base of the culture vessel may be mechanically cleaned by hand using non-porous acrylic scrapers. Particulate matter is removed via siphoning. All instruments or tools that come into contact with the culture medium are sanitized and rinsed prior to use—either by ethanol immersion or autoclave sterilization, depending on the composition and size of the item.

Lighting conditions are controlled via LED fixtures providing a photosynthetically active radiation (PAR) output between 70 and 100 μmol photons/m²/s, operated on a reverse day/night cycle for approximately 8 to 10 hours per day. This relatively low PAR range is sufficient for photosynthetic maintenance of the dinoflagellates while also inhibiting undesirable algal growth, thereby contributing both to organismal health and exhibit visibility.

As shown in the schematic view of FIG. 1A and the images of FIGS. 1B-1C, the bioluminescent microorganism exhibit 100 comprises a plurality of air conduits 112a-f positioned above the surface of the water, with nozzles positioned above the surface of the water and oriented to blow compressed air onto the surface of the water. Each nozzle may be embodied as an open end of an air conduit 112a-f or a component secured within an open end of an air conduit 112a-f and configured to manipulate the flow of compressed air exiting the air conduit 112a-f to have a desired flow rate and shape of air flow (e.g., solid cone shaped air flow to disturb a circular area on the surface of the water; a fan shaped air flow to disturb a linear area on the surface of the water; and/or the like). Moreover, the nozzles may have any of a variety of orientations relative to the surface of the water. The nozzles may be oriented perpendicular to the surface of the water (to blow air vertically down onto the surface of the water) or the nozzles may be oriented at an angle between perpendicular and parallel. By angling the nozzles, the nozzles may impact a larger excitation area on the surface of the water. In certain embodiments, the air conduits 112a-f are partially submerged below the surface of the water so the nozzles disperse blown air into the water directly, creating bubbles.

It should be understood that any nozzle configuration that directs air onto the surface of the water may be provided in embodiments as discussed herein. Each nozzle is oriented to disturb an excitation area on the surface of the water with compressed air exiting a corresponding air conduit 112a-f through the nozzle. In some embodiments, the excitation areas of two or more nozzles overlap. In some embodiments, the excitation areas of all of the nozzles are spatially separated. In some embodiments, the entire surface of the water is positioned within at least one excitation area. In some embodiments, only a portion of the surface of the water is positioned within at least one excitation area.

As shown in FIGS. 1A-1C, the bioluminescent microorganism exhibit 100 comprises a support structure for the nozzles and air conduits 112a-f to maintain a desired positioning and orientation of the nozzles and air conduits 112a-f. As shown, the nozzles are spatially distributed above the surface of the water. In the illustrated embodiment, the support structure comprises a plurality of rigid tubes (e.g., polyvinyl chloride (PVC) tubes). In the illustrated embodiment, the PVC tubes have holes extending laterally therethrough, and the air conduits 112a-f are routed through the holes. In some embodiments, the nozzles are rigidly secured within the holes. In other embodiments, the air conduits 112a-f are friction-fit into the holes of the PVC tubes, and the nozzles are secured onto an end of each air conduit 112a-f. It should be understood that the illustrated embodiment is merely an example, and other support structures may be provided in other embodiments (e.g., a continuous plate extending across an open top of the aquarium with holes drilled therethrough for supporting the air conduits 112a-f; a metal structure; and/or the like).

The bioluminescent microorganism exhibit 100 further comprises control hardware 108. The control hardware 108 is comprised of a power supply, a program replay unit, a valve controller, a manifold distribution system, one or more valves, one or more compressed air sources, air conduits, an air regulator, and an audio system output. The control hardware 108 is configured control the bursts of air on the surface of the water to be in time with a music sequence. The control hardware 108 receives compressed air from one or more compressed air sources 110. In certain embodiments, the one or more compressed air sources 110 may comprise air compressors, compressed air tanks, and/or a fluid pump. The control hardware 108 disperses the compressed air through a manifold distribution system comprising a plurality of valves. As discussed in greater detail herein, operating a valve of the plurality of valves to an open configuration directs compressed air into of the air conduits 112a-f that are in fluid communication with the opened valve (and consequently, to one or more of the nozzles 114a-f). The valves may be independently operable by the control hardware 108, thereby enabling control of when each of the nozzles 114a-f blow compressed air onto the surface of the water to excite the bioluminescent dinoflagellates. The control hardware 108 releases the compressed air from the one or more compressed air sources 110 through air conduits 112a-f and their respective spatially distributed air nozzles 114a-f on to the surface of the water 104.

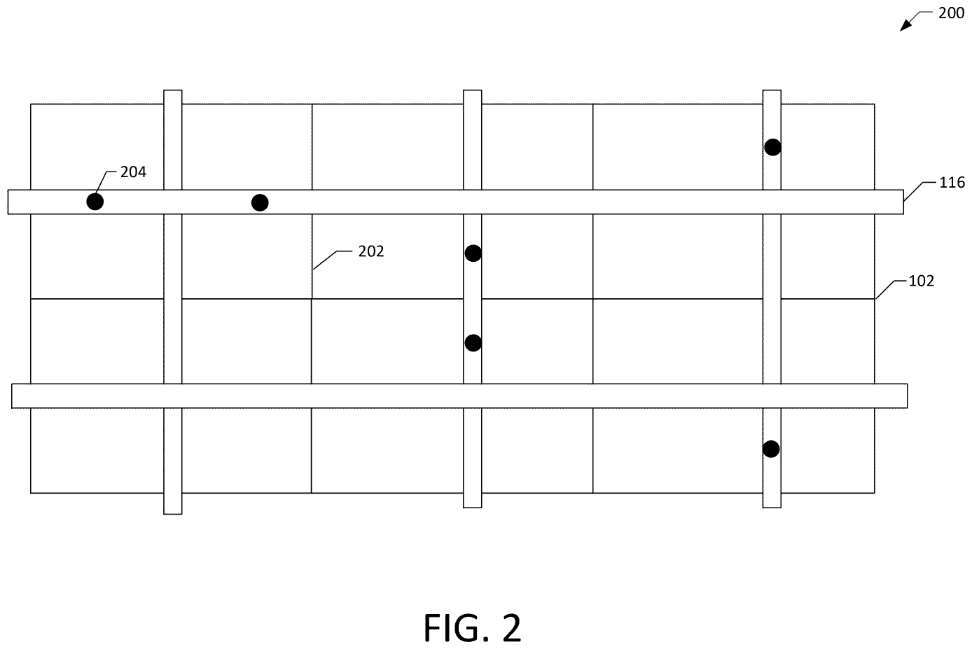

FIG. 2 provides a schematic of the top view of the aquarium exhibit, according to embodiments of the present disclosure. As shown in the top view, the spatially distributed air nozzles 204 may be distributed in two dimensions above the surface of the water. In some embodiments, the spatially distributed air nozzles 204 are positioned within a single plane (parallel to the surface of the water). The air nozzles are supported on a support structure that may extend in one or two dimensions relative to the aquarium. As shown the support structure rests on edges of the aquarium and stabilizes the spatially distributed air nozzles 204. The spatially distributed air nozzles 204 are dispersed throughout the support structure 116 so that the microorganisms 106 are excited to luminesce in different portions of the aquarium tank 102.

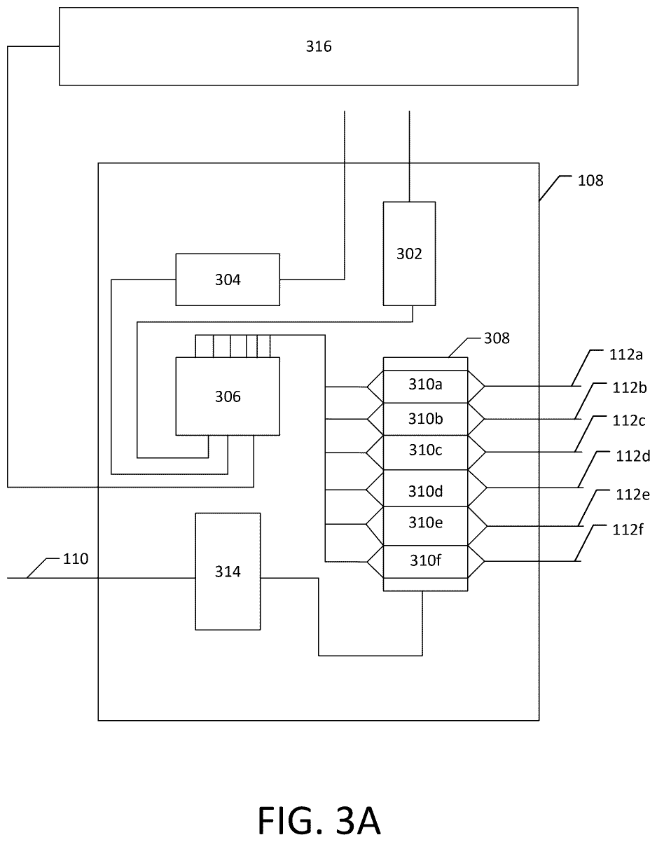

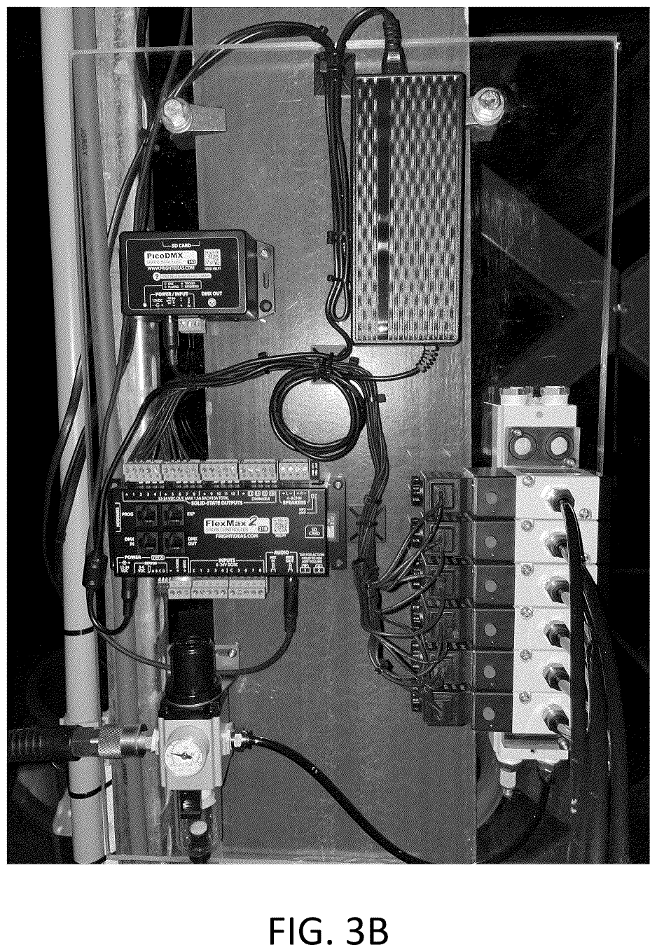

In the illustrated embodiment of FIG. 3, the aquarium tank 102 comprises a plurality of modular trays 202 that may be arranged in a grid. In certain embodiments, each tray of the modular grid 202 is removeable and/or replaceable. The bioluminescent dinoflagellates are positioned in the removable trays, so that the trays may be periodically removed from the aquarium and replaced. Over time, the bioluminescent dinoflagellates can become over-stimulated, and so those trays can be removed from an exhibit and placed into a storage area where the bioluminescent dinoflagellates within the removed tray are not subject to stimulation for a period of time. Other trays that were previously in storage can then be placed into the aquarium exhibit for stimulation.

In certain embodiments, the support structure comprises one or more mechanical components configured to move one or more of the spatially distributed air nozzles 114a-f. For example, the one or more mechanical components may comprise motors, actuators, wheels, gears, tracks, and/or the like that collectively operate to move one or more nozzles and/or one or more components of the support structure. In some embodiments, a valve controller as discussed herein may be configured to transmit signals to the one or more mechanical components to cause those mechanical components to move. In certain embodiments, the spatially distributed air nozzles 114a-f may be mounted on a track, fitted with a motor, and are configured to move to different sections of the modular grid 202 of the aquarium tank 102. In some embodiments, the position of the spatially distributed air nozzles 114a-f may be controlled by the valve controller 206 and may be choreographed to move in synchronization with an audio track.

FIG. 3A is a schematic of a hardware system (an example of which is shown in FIG. 3B), according to embodiments of the present disclosure. The control hardware 108 comprises a power supply 302, a program replay unit 304, a valve controller 306, a manifold distribution system 308, one or more valves 310a-f, one or more compressed air sources 110, air conduits 112a-f, an air regulator 314, and an audio system output 316. The power supply 302 receives electricity from one or more electrical sources to power the valve controller 306. The program replay unit 304 also receives electricity from one or more electrical sources (e.g., a building power supply, such as an electrical outlet; a battery, a generator, a solar panel, and/or the like).

The one or more valves 210a-f are in fluid communication with the compressed air source 110, such that compressed air is directed to each of the valves 210a-f. The valves 210a-f may be arranged in parallel with respect to the compressed air source 110, such that each valve 210a-f receives at least substantially the same pressure of compressed air. The one or more valves 210a-f are operable between a closed configuration and an open configuration. In the closed configuration, compressed air is prevented from passing through the valve 210. In the open configuration, the valve 210 permits air to flow through the valve 210 (e.g., to an air conduit 112a-f). In some embodiments, each of the valves 210a-f are operable in a binary fashion, such that the valves 210a-f are entirely closed (so no compressed air passes therethrough) or entirely open (so that the valve does not impede flow of air therethrough). In other embodiments, the valves 210a-f can be opened partially to manipulate the flow of air through the valve 210 (and consequently to modify the pressure of air exiting connected nozzles onto the surface of the water), and the amount of opening of a valve 210 can be controlled by the control hardware 108 providing signals to the valve.

Each valve of the one or more valves 310a-f is in fluid communication with at least one air conduit 112a-f. For example, a valve 310 may be connected with an end of an air conduit 112, such that air leaving the valve enters the air conduit when the valve is in the open configuration. In some embodiments, only a single air conduit is in fluid communication with a single valve. That single air conduit may comprise a single nozzle, such that operating the valve operates the single nozzle independently. In other embodiments, the single air conduit may comprise a plurality of nozzles (e.g., arranged in series), such that operating the valve operates all of the plurality of nozzles of the single air nozzle. When air nozzles are arranged in series, the pressure exiting each of the plurality of air nozzles may differ (e.g., the air nozzle farthest from the valve may have the lowest air exit pressure). In yet other embodiments, a plurality of air conduits may be connected with a single valve (e.g., in series or in parallel). Where multiple air conduits are arranged in parallel (e.g., each with a single nozzle), the system maintains substantially equal air pressure at each nozzle for blowing onto the surface of the water. Each of the plurality of air conduits may have a single nozzle or a plurality of nozzles. In this way, a single valve may be configured to control one or more air nozzles. In some embodiments, a valve controller 206 stores metadata describing which nozzles are controlled by each valve.

In certain embodiments, the valve controller 306 is a valve controller configured to activate each of the plurality of valves by providing an electrical signal to a valve. A valve controller 206 is a device that regulates and controls the operation of one or more valves 310a-f between the open configuration and the closed configuration. When the valve controller 306, activates one of the plurality of valves 310a-f, compressed air is directed through connected air conduits 112a-f and exits through spatially distributed air nozzles 114a-f connected with the valve. As discussed above, each of the one or more valves 310a-f may control a single spatially distributed nozzle 114a-f. In certain embodiments, a single one of the one or more valves 310a-f controls multiple air conduits 112a-f and the spatially distributed nozzles 114a-f arranged in series or in parallel.

In some embodiments, the pressure and duration of the air discharged from the spatially distributed air nozzles 114a-f directly influences the degree of bioluminescent response exhibited by the microorganisms 106. In certain embodiments, variations in the intensity of mechanical stimulation correlate with corresponding variations in light emission. In some embodiments, lower-pressure, shorter-duration air bursts produce significantly diminished or negligible luminescent reactions when compared to higher-pressure, longer-duration bursts. It should be noted, however, that the perceived brightness is partially subjective and contingent upon external biological and environmental variables, such as the overall health of the dinoflagellate culture (i.e., microorganisms 106) and the level of photosynthetic energy accumulated during prior rest and light exposure cycles. Thus, the range of effective stimulation pressures is variable and influenced by multiple dynamic factors. While higher-pressure and longer-duration air bursts tend to produce more pronounced bioluminescent responses, the threshold for activation is not absolute and can fluctuate depending on the physiological condition of the culture, including but not limited to, cellular health, density, and the amount of photosynthetic energy stored during their prior rest and light exposure cycles.

In certain embodiments, the one or more air conduits 112a-f with the one or more valves 310a-f maintain at least substantially consistent air pressure at each of the spatially distributed air nozzles 114a-f. The one or more valves 310a-f form the manifold distribution system 308. The manifold distribution system 308 is connected to the valve controller 306.

The valve controller 306 is configured to activate each of the plurality of valves, and by extension, to activate each of the plurality of spatially distributed air nozzles 114a-f in accordance with a temporal sequence defining a plurality of activation times for activating one or more of the plurality of spatially distributed air nozzles. In certain embodiments, the temporal sequence defines the order in which the spatially distributed air nozzles 114a-f are activated over a period of time. In some embodiments, the temporal sequence is stored in the program replay unit 304 although it should be understood that it could be stored in memory elsewhere, such as a network-accessible, non-transitory memory storage area that is in network communication with the valve controller 306. In certain embodiments, the program replay unit is a non-transitory memory. In certain embodiments, the temporal sequence identifies a set of one or more of the plurality of spatially distributed air nozzles 114a-f for activation at each of the plurality of activation times.

In certain embodiments, the valve controller 306 is configured to activate sets of the spatially distributed air nozzles 114a-f. A set of spatially distributed air nozzles 114a-f is defined as a subset of the plurality of spatially distributed air nozzles 114a-f that are activated simultaneously (at a single activation time). A set of spatially distributed air nozzles 114a-f may be defined by a single air nozzle or a plurality of air nozzles. In certain embodiments, a set of spatially distributed air nozzles 114a-f are activated by the activation of one valve such as valve 310a. In such an instance, activation of a set of spatially distributed air nozzles comprises sending a single to the single valve 310a for activation. In other embodiments, a set of spatially distributed air nozzles may comprise air nozzles controlled by different valves, so that activation of the set of spatially distributed air nozzles comprises sending signals to a plurality of valves. In certain embodiments, a first set of spatially distributed nozzles are activated at a first activation time. A different set from the first set of spatially distributed air nozzles 114a-b are activated during subsequent activation times of the plurality of activation times. For example, if spatially distributed air nozzles 114a and 114b are activated in a first set, spatially distributed air nozzles 114c and 114d may be activated in a second set as a subsequent time.

In certain embodiments, the valve controller 306 synchronizes the temporal sequence with music by initializing the temporal sequence simultaneously with initiation of an audio track. For example, the valve controller 306 coordinates the activation of a single spatially distributed air nozzle 114a-f or a set of spatially distributed air nozzles 114a-f to activate in time with the rhythm of a song in order to produce a choreographed display of bioluminescence. The temporal sequence can be programmed manually, such that the synchronization is a matter of manual choreography based on a particular audio track. In some embodiments, the temporal sequence can be determined automatically. The temporal sequence is set, such that it is always the same for the particular audio track. In alternative embodiments, the temporal sequence may be determined in real-time, which may result in differences for the temporal sequence each time the audio track is played.

To initiate the temporal sequence simultaneously with initiation of an audio track (e.g., a song), the valve controller 306 receives input indicating initialization of an audio track from the audio system output 316. In response, the valve controller 306 initiates a temporal sequence stored in the program replay unit 304 to begin simultaneously with the beginning of the audio track. The valve controller 306 sends signals to one or more valves 310a-f at activation times. In certain embodiments, each activation time is a different length. For example, at time 1, the active nozzles remain active for one second, at time 2, the active nozzles remain active for 2 seconds. In certain embodiments, the activate times may overlap. In certain embodiments, the activation times could be discrete and non-overlapping.

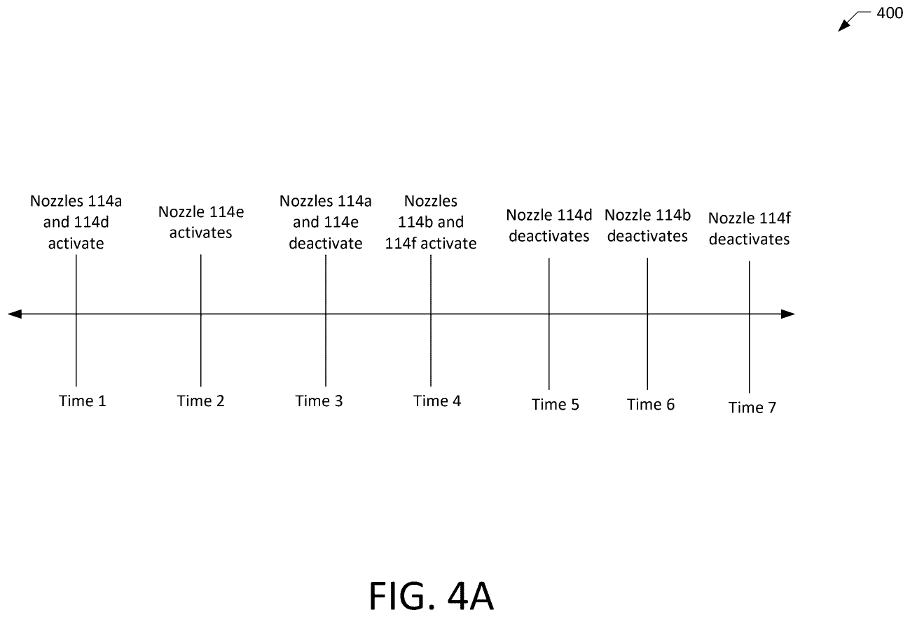

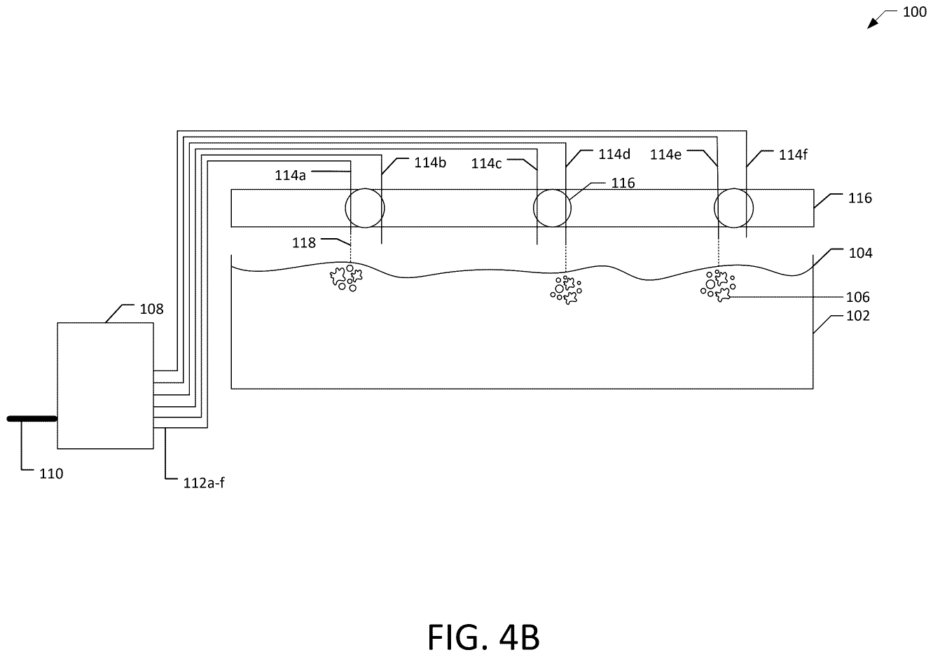

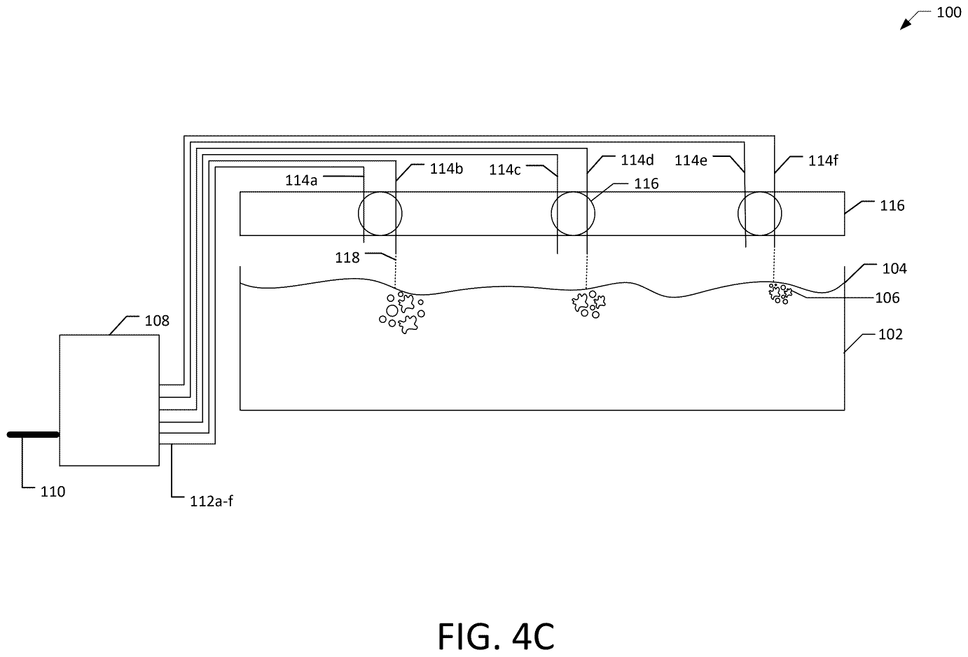

FIG. 4A provides a timeline of example activation times, during which nozzles are activated and deactivated, according to embodiments of the present disclosure. The timeline 400 begins at Time 1. Time 1 is the first instance during a temporal sequence in which at least one nozzle is activated during a temporal sequence. However, it should be understood that time 1 does not need to occur simultaneously with the beginning of an audio track. Said differently, the temporal sequence may begin before time 1 (e.g., at time 0, not shown).

At Time 1, nozzles 114a and 114d activate. At Time 2, nozzle 114e activates. At Time 3, nozzles 114a and 114e deactivate. At Time 4, nozzles 114b and 114f activate. At Time 5, nozzle 114d deactivates. At Time 6, nozzle 114b deactivates. At Time 7, nozzle 114f deactivates. Timeline 400 is further illustrated in FIGS. 4D and 4C.

FIG. 4B depicts a schematic of a bioluminescent microorganism exhibit 100 with active nozzles according to the timeline of FIG. 4A, at a time between time 2 and time 3. As shown, nozzles 114a and 114d are active (per activation at time 1), and nozzle 114e is active (per activation at time 2). The bioluminescent microorganism exhibit 100 is comprised of an aquarium tank 102, water 104, control hardware 108, one or more compressed air sources 110, air conduits 112a-f, spatially distributed nozzles 114a-f, support structure 116, blown air 118, and microorganisms 106. Spatially distributed nozzles 114a, 114d, and 114e are active. Thus, blown air 118 is being directed from spatially distributed air nozzles 114a, 114d, and 114e on to the surface of the water 104 and exciting microorganisms 106 to luminesce.

FIG. 4C depicts a schematic of the same aquarium exhibit as shown in FIG. 4B, with active nozzles according to the timeline of FIG. 4A, at a time between time 4 and time 5. As shown, nozzles 114b and 114f are active (per activation at time 4), and nozzle 114d is active (per activation at time 1). Spatially distributed air nozzles 114b, 114d, and 114f are active. Thus, blown air 118 is being directed from the spatially distributed air nozzles 114b, 114d, and 114f on to the surface of the water 104 and exciting microorganisms 106 to luminesce.

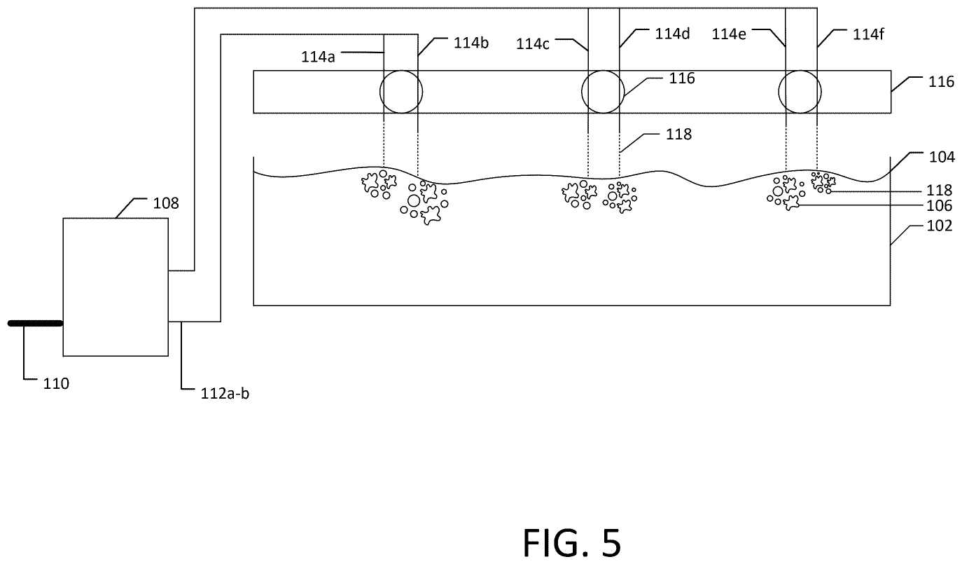

FIG. 5 depicts a schematic of an aquarium exhibit with multiple nozzles controlled by a single valve, according to embodiments of the present disclosure. The bioluminescent microorganism exhibit 100 comprises an aquarium tank 102, water 104, control hardware 108, one or more compressed air sources 110, air conduits 112a-f, spatially distributed nozzles 114a-f, support structure 116, blown air 118, and microorganisms 106. Nozzles 114a and 114b are connected to air conduit 112a. Air conduit 112a separates into nozzles 114a and 114b. When the valve connected to air conduit 112 a is activated, blown air 118 is directed from both nozzles 114a and 114b. Air nozzles 114c, 114d, 114e, and 114f are connected to air conduit 112b. Air conduit 112 connects nozzles 114c-f in parallel. When the valve connected to air conduit 112b is activated, blown air 118 is directed from nozzles 114c-f.

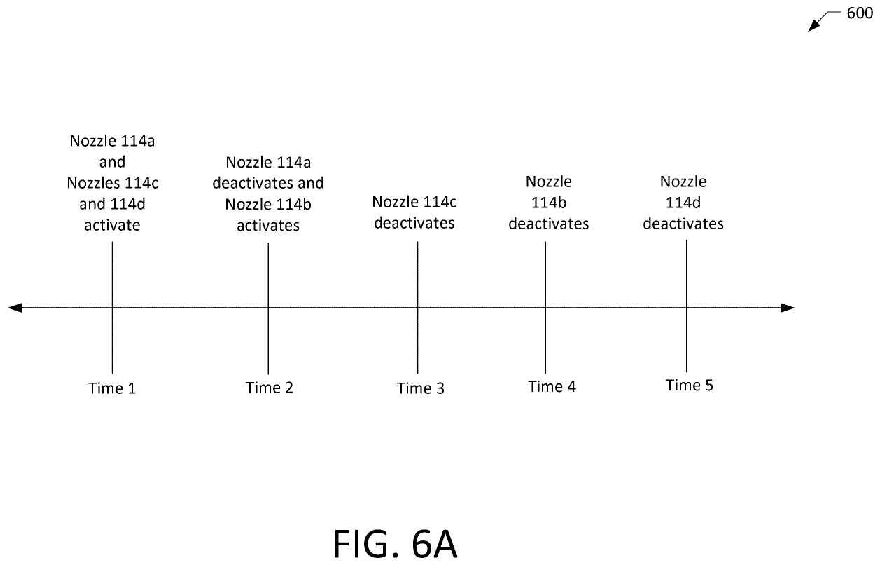

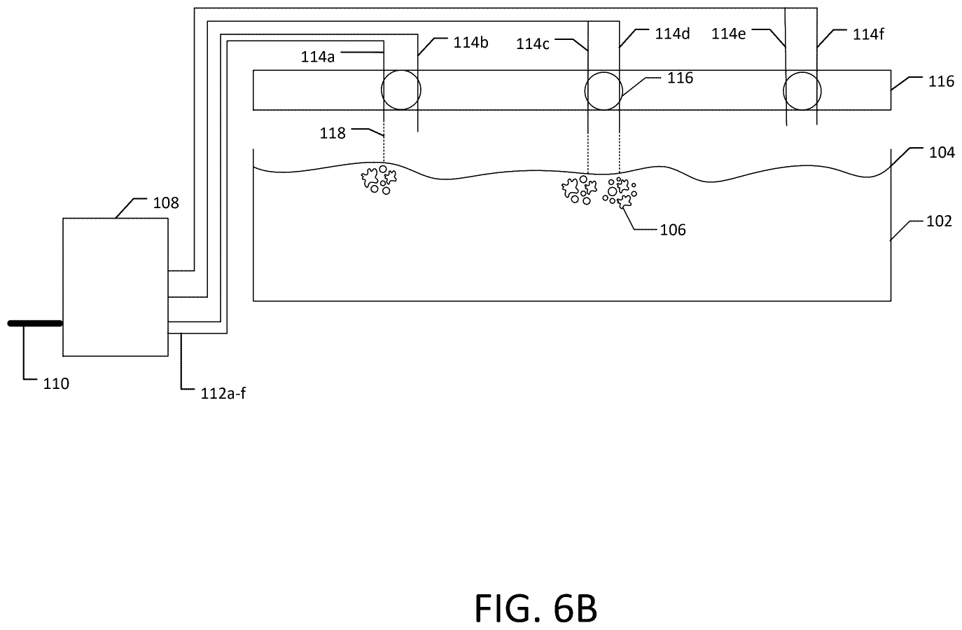

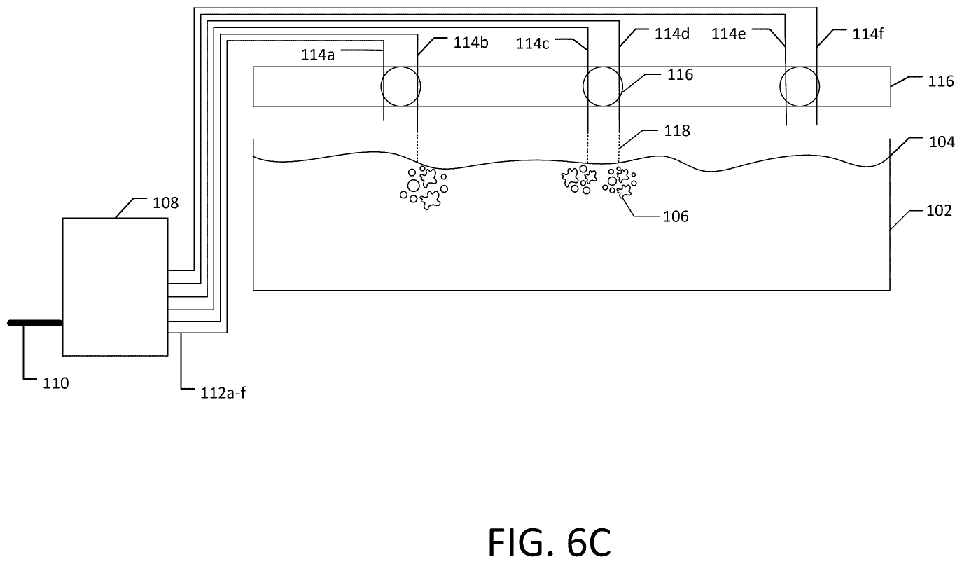

FIG. 6A provides a timeline of example activation times, during which nozzles are activated and deactivated, according to embodiment of the present disclosure. The timeline 600 begins at Time 1. Time 1 is the first instance during a temporal sequence in which at least one nozzle is activated during a temporal sequence. However, it should be understood that Time 1 does not need to occur simultaneously with the beginning of an audio track. Said differently, the temporal sequence may begin before Time 1 (e.g., at Time 0, not shown).

At Time 1, nozzle 114a and nozzles 114c and 114d are activated. At time 2, nozzle 114a deactivates and nozzle 114b activates. At time 3, nozzle 114c deactivates. At time 4, nozzle 114 deactivates. At time 5, nozzle 114d deactivates. Timeline 600 is further illustrated in FIGS. 6B and 6C.

FIG. 6B depicts a schematic of an aquarium exhibit with activate nozzles according to the timeline of FIG. 6A, at Time 1. As shown, nozzles 114a, 114c, and 114d are active (per activation at time 1). The bioluminescent microorganism exhibit 100 is comprised of an aquarium tank 102, water 104, control hardware 108, one or more compressed air sources 110, air conduits 112a-f, spatially distributed nozzles 114a-f, support structure 116, blown air 118, and microorganisms 106. Spatially distributed air nozzles 114a, 114c, and 114d are active. Thus, blown air 118 is being directed from spatially distributed air nozzles 114a, 114d, and 114e on to the surface of the water 104 and exciting microorganisms 106 to luminesce. Nozzle 114a is a single nozzle controlled by a single valve. Nozzles 114c and 114d are multiple nozzles controlled by a single valve.

FIG. 6C depicts a schematic of the same aquarium exhibit as shown in FIG. 6B, with active nozzles according to the timeline of FIG. 6A, at time 2. As shown, 114c and 114d are active (per activation at time 1), and nozzle 114b is active (per activation at time 2). Spatially distributed air nozzles 114b, 114c, and 114d are active. Thus, blown air 118 is being directed from the spatially distributed air nozzles 114b, 114c, and 114d on to the surface of the water 104 and exciting microorganisms 106 to luminesce.

### Method of Programming a New Temporal Sequence

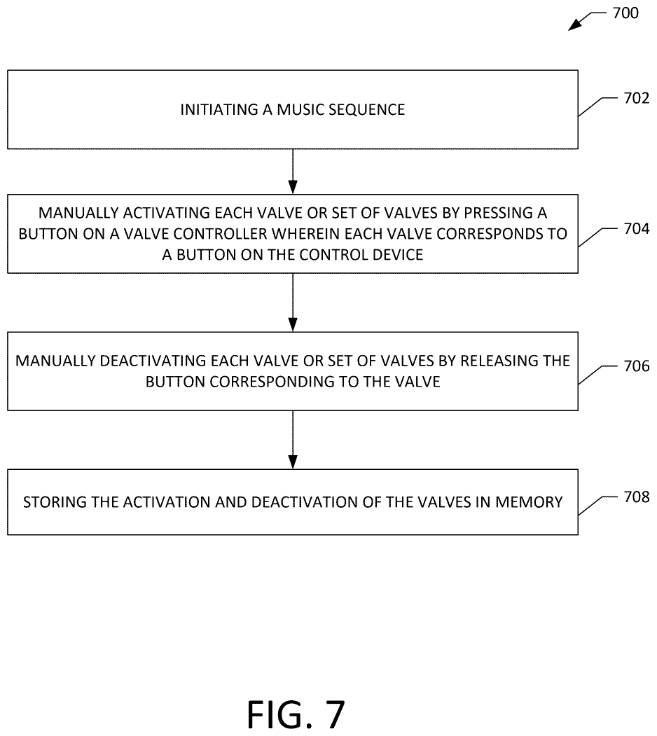

FIG. 7 is a block diagram depicting a method 700 of programming a new temporal sequence, according to embodiments of the present disclosure.

At step 702, a music sequence is initiated. The music sequence may be comprised of a single song or a plurality of songs. The music sequence may be trimmed to a specific length or have no certain length.

At step 704, a user manually activates each valve or a set of valves by pressing a button on the valve controller 306. The valve controller 306 is connected to an input device. The valve controller 306 and the input device may be connected by a wire or wirelessly. The input device comprises buttons that correspond to one or more valves 210a-f that are connected to the valve controller 306. The input device may be a keyboard. When the user depresses a button/key on the input device/keyboard a corresponding communication signal is sent through a wire, or wirelessly through a network, to the electronic controller which activates one or more valves 210a-f to blow air on the surface of the water 104 of the aquarium tank 102 through one or more spatially distributed air nozzles 114a-f.

At step 706, the button depressed by the user is released to deactivate valve or set of valves activated in step 704.

At step 708, the selection and activation of the valve is stored in memory. In certain embodiments, the memory is the program replay unit. In certain embodiments, the sequence of the activation of a valve or a set of valves is saved to the memory as a temporal sequence.

### Method of Use

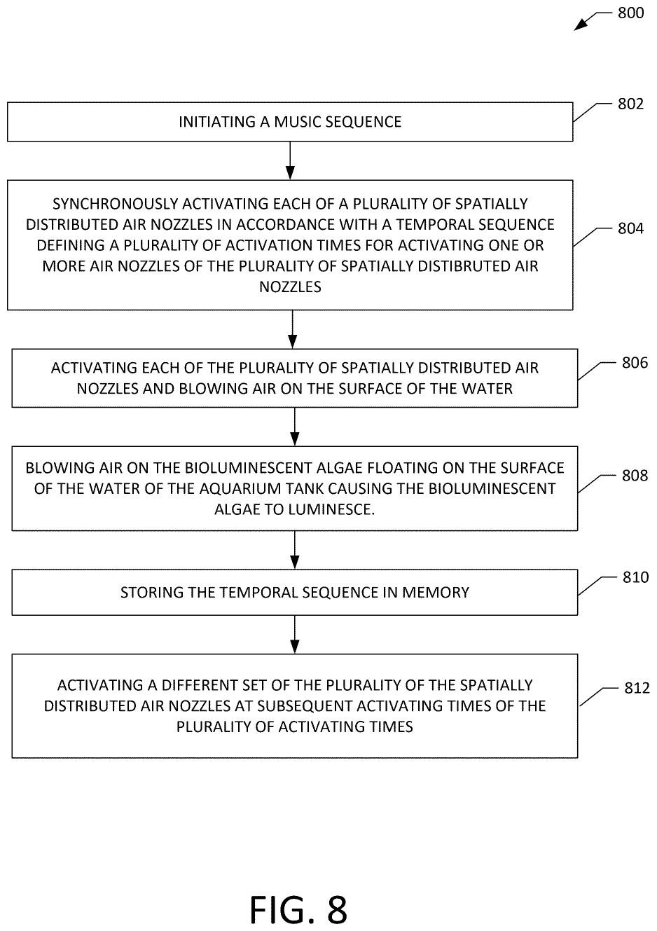

FIG. 8 is a block diagram depicting a method 800 of exciting microorganisms to luminesce, according to embodiments of the present disclosure.

At step 802, a music sequence is initiated. In certain embodiments, the music sequence is initiated by the audio output system. The music sequence may be comprised of a single song or multiple songs. In certain embodiments the music sequence is a specific amount of time. In certain embodiments the music may be an undefined length of time.

At step 804, each of a plurality of spatially distributed air nozzles 114a-f is synchronously activated in accordance with a temporal sequence defining a plurality of activation times for activating one or more air nozzles 114a-f or the plurality of spatially distributed air nozzles 114a-f. In certain embodiments, activating an air nozzle 114 of the plurality of spatially distributed air nozzles 114a-f comprises releasing compressed air from the air nozzle.

At step 806, each of the plurality of spatially distributed air nozzles are activated and air is blown on the surface of the water.

At step 808, air is blown on to the bioluminescent algae 106 floating on the surface of the water 104 of the aquarium tank 102 causing the bioluminescent algae 106 to luminesce.

At step 810, the temporal sequence is stored in memory. In certain embodiments, the temporal sequence identifies a set of one or more of the plurality of spatially distributed air nozzles 114a-f for activation at each of the plurality of activation times.

At step 812, a different set of the plurality of the spatially distributed air nozzles 114a-f are activated at subsequent activating times of the plurality of activating times.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system comprising:
one or more compressed air sources;
a plurality of spatially distributed air nozzles connected with the one or more compressed air sources by one or more air conduits; and
an electronic controller configured to activate each of the plurality of spatially distributed air nozzles in accordance with a temporal sequence defining a plurality of activation times for activating one or more air nozzles of the plurality of spatially distributed air nozzles.

2. The system of claim 1, further comprising an aquarium tank.

3. The system of claim 2, wherein the plurality of spatially distributed air nozzles are located above a water surface of the aquarium tank and each of the plurality of spatially distributed air nozzles is oriented to blow air onto the water surface.

4. The system of claim 3, wherein the aquarium tank includes bioluminescent algae floating on the water surface; and blowing air causes the bioluminescent algae to luminesce.

5. The system of claim 1, wherein the plurality of spatially distributed air nozzles are defined within a single plane.

6. The system of claim 1, wherein the temporal sequence is stored in memory, and wherein the temporal sequence identifies a set of one or more of the plurality of spatially distributed air nozzles for activation at each of the plurality of activation times.

7. The system of claim 1, wherein a different set of the plurality spatially distributed air nozzles are activated during subsequent activation times of the plurality of activation times.

8. The system of claim 1, wherein the electronic controller synchronizes the temporal sequence with music by initiating the temporal sequence simultaneously with initiation of a song.

9. The system of claim 1, wherein the electronic controller receives input indicating initiation of a song and initiates the temporal sequence.

10. The system of claim 1, wherein nozzles are controlled using solenoid valves.

11. The system of claim 1, wherein the one or more air conduits are part of an air distribution manifold, and wherein the air distribution manifold maintains at least substantially consistent air pressure at each nozzle.

12. The system of claim 1, wherein at least one nozzle is moveable.

13. A method comprising:
initiating a music sequence; and
synchronously activating each of a plurality of spatially distributed air nozzles in accordance with a temporal sequence defining a plurality of activation times for activating one or more air nozzles of the plurality of spatially distributed air nozzles;
wherein activating an air nozzle of the plurality of spatially distributed air nozzles comprises releasing compressed air from the air nozzle.

14. The method of claim 13, further comprising an aquarium tank.

15. The method of claim 14, further comprising:
activating each of the plurality of spatially distributed air nozzles and blowing air on the surface of the water.

16. The method of claim 15, further comprising:
blowing air on the bioluminescent algae floating on the surface of the water of the aquarium tank causing the bioluminescent algae to luminesce.

17. The method of claim 13, further comprising:
defining the plurality of spatially distributed air nozzles within a single plane.

18. The method of claim 13, further comprising:
storing the temporal sequence in memory, wherein the temporal sequence identifies a set of one or more of the plurality of spatially distributed air nozzles for activation at each of the plurality of activation times.

19. The method of claim 13, further comprising:
activating a different set of the plurality of the spatially distributed air nozzles at subsequent activation times of the plurality of activation times.

20. The method of claim 13, further comprising:
Controlling the nozzles using solenoid valves.
